(19) United States
(12) Patent Application Publication
(10) Pub. No.: US 2018/0084948 A1
(43) Pub. Date: Mar. 29, 2018

(54) COMBINATION PRESSURE AND OPEN FRYING APPARATUS

(71) Applicant: Henny Penny Corporation, Eaton, OH (US)

(72) Inventors: Kimberly Eros, Dayton, OH (US); Richard W. Cartwright, Piqua, OH (US); Steven J. Long, Edwardsville, IL (US)

(73) Assignee: Henny Penny Corporation, Eaton, OH (US)

(21) Appl. No.: 15/561,569

(22) PCT Filed: Mar. 28, 2016
(86) PCT No.: PCT/US2016/024530

§ 371 Date: Sep. 26, 2017

Related U.S. Application Data
(60) Provisional application No. 62/139,537, filed on Mar. 27, 2015.

(51) Int. Cl. A47J 37/12; A47J 36/10

(52) U.S. Cl. CPC A47J 37/12; A47J 37/128; A47J 36/10

(57) ABSTRACT

A fryer apparatus includes a selectively closeable frypot to alternate a mechanism of operation between an open frying platform and a pressure frying platform. The selectively closeable frypot includes a cover with a locking mechanism disposed within the cover that is actuated by rotation of a handle such that the footprint of the selectively closeable frypot may be sized comparable with a typical open frypot to accommodate space constraints of limited service restaurants. The fryer apparatus may also include a pressure assist feature so that the selectively closeable frypot efficiently reaches a desired pressure for smaller batches of food product when used as a pressure frying platform.

### CROSS-REFERENCE TO RELATED APPLICATION

This application claims priority to U.S. Provisional Patent Application Ser. No. 62/139,537, filed Mar. 27, 2015, which is incorporated by reference herein in its entirety.

### BACKGROUND OF THE INVENTION

Applicants have identified unmet needs among foodservice operators and their frying equipment. Competition for consumer's share of foodservice money is driving operators to add higher quality menu items. Consumer demand is increasing for fresh, boneless, chicken menu offerings. Pressure frying offers significant advantages as a cooking style when it comes to proteins like chicken. It helps to seal in a protein's moisture creating a more desirable end product to consumers while also creating conditions that allow for the breaded protein to be held before serving for a significantly longer time than open frying. However, back-of-house spatial constraints in restaurants may not permit the use of a stand-alone pressure fryer used for only a few menu items. Often, these kitchens require smaller, more efficient, more versatile equipment to prepare small batches of fresh boneless chicken. Thus, open fryers that are preferable for cooking other food products, such as french fries, are typically used because they have been viewed as more flexible than pressure fryers. It is desirable to deliver a combination pressure/open frying platform that provides advantages of pressure frying while still having the flexibility of an open fryer. Such a fryer will adapt to boneless chicken eating preferences and a combination pressure/open frying platform or fryer is designed to satisfy those customer demands.

### SUMMARY OF THE INVENTION

A combination pressure and open frying apparatus may include at least one selectively closeable frypot configured to cook food product, the selectively closeable frypot has an access opening for food product. The selectively closeable frypot includes a cover to selectively close the access opening and seal the selectively closeable frypot. The cover is movable from a closed position to an open position, the cover also includes a locking mechanism disposed within that is configured to lock the cover in the closed position. The cover also includes a handle offset from a front of the cover that is configured to actuate the locking mechanism, such that the handle may move from a locked position that locks the cover and an unlocked position that unlocks the cover.

The locking mechanism may include a pin extending in a width direction of the cover that is operatively coupled to a latch. The pin is coupled to the handle and configured to move the latch in a direction generally perpendicular to the width direction to selectively lock the cover. As the pin rotates, the latch may through an opening in the front of the cover to engage a strike to lock the cover. The selectively closeable frypot is configured to operate as a pressure frying platform when the cover is locked in the closed position and the selectively closeable frypot is configured to operate as an open pressure frying platform when the cover is in the open position.

### BRIEF DESCRIPTION OF THE DRAWINGS

FIG. 1 is a perspective view of a fryer apparatus, according to an embodiment of the invention.

FIG. 2a is a perspective view of a cover for a selectively closeable frypot in an unlocked configuration, according to an embodiment of the invention.

FIG. 2b is a perspective view of a cover for a selectively closeable frypot in a locked configuration, according to an embodiment of the invention.

FIG. 3a is a perspective view of a fryer apparatus proximate a ventilation hood, according to an embodiment of the invention.

FIG. 3b is a side view of the fryer apparatus of FIG. 3a with a cover for a selectively closeable frypot in an open position, according to an embodiment of the invention.

FIG. 4 is a perspective view of a rear hinge of a cover for a selectively closeable frypot, according to an embodiment of the invention.

FIG. 5 is a partial cut away perspective view of a selectively closeable frypot, according to an embodiment of the invention.

FIG. 6a is an elevation view of a cover for a selectively closeable frypot, according to an embodiment of the invention.

FIG. 6b is a cross-sectional view of a locking mechanism for a cover of a selectively closeable frypot in an unlocked configuration, according to an embodiment of the invention.

FIG. 6c is a cross-sectional view of the locking mechanism of FIG. 6b in a locked configuration, according to an embodiment of the invention.

FIG. 7 is a plan view of a locking mechanism for a cover of a selectively closeable frypot, according to an embodiment of the invention.

### DETAILED DESCRIPTION OF EMBODIMENTS OF THE INVENTION

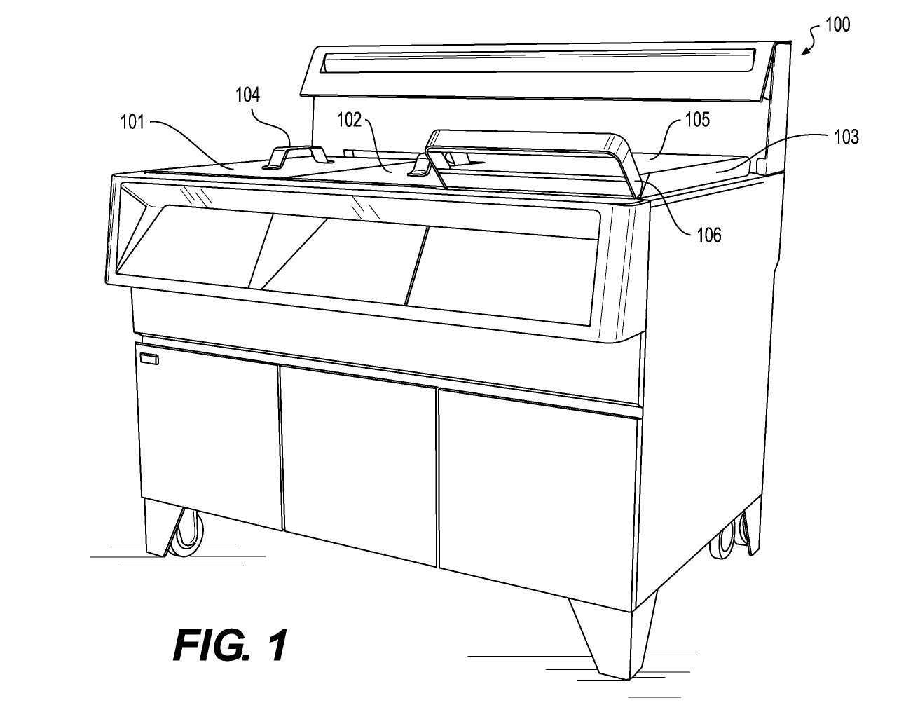

A combination fryer may have a varied configuration of open and closable fry pots. Alternatively, a combination fryer may have a single fry pot that is selectively closable to be used as either an open fryer or a pressure fryer depending on the food product and desired cooking result. As shown in FIG. 1, fryer apparatus 100 includes two open frypots 101, 102 suitable for open frying and a selectively, closable frypot 103 that is suitable for pressure or open frying. Open frypots 101, 102 may be covered by lid 104 when not in use. Closable frypot 103 may include an access opening for food product that may be selectively closed by cover 105, which can be locked to seal closable frypot 103 and permit pressure to build up adequately for use as a pressure frying platform.

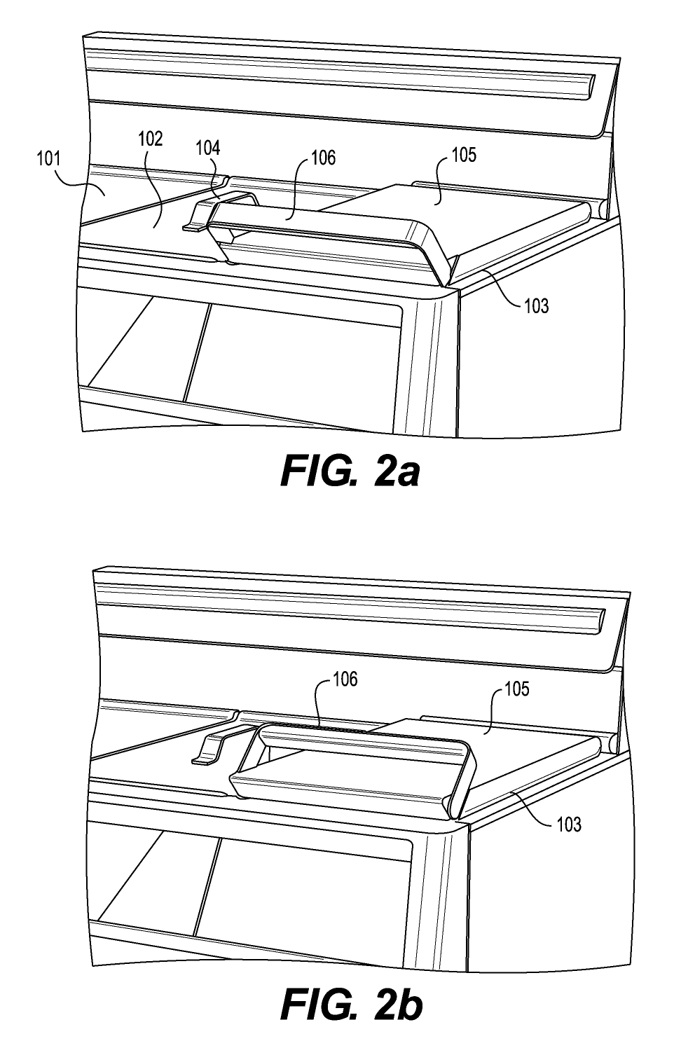

FIG. 2a shows closable frypot 103 in an unlocked state. To facilitate locking and unlocking of closable frypot 103 for use as a pressure fryer, cover 105 may be provided with a locking mechanism actuated by handle 106 that fits within the footprint of fryer apparatus 100 in consideration of potential spatial restraints. FIG. 2b illustrates handle 106 in an actuated position that causes locking mechanism to lock closable frypot 103 so that it can be used for pressure frying.

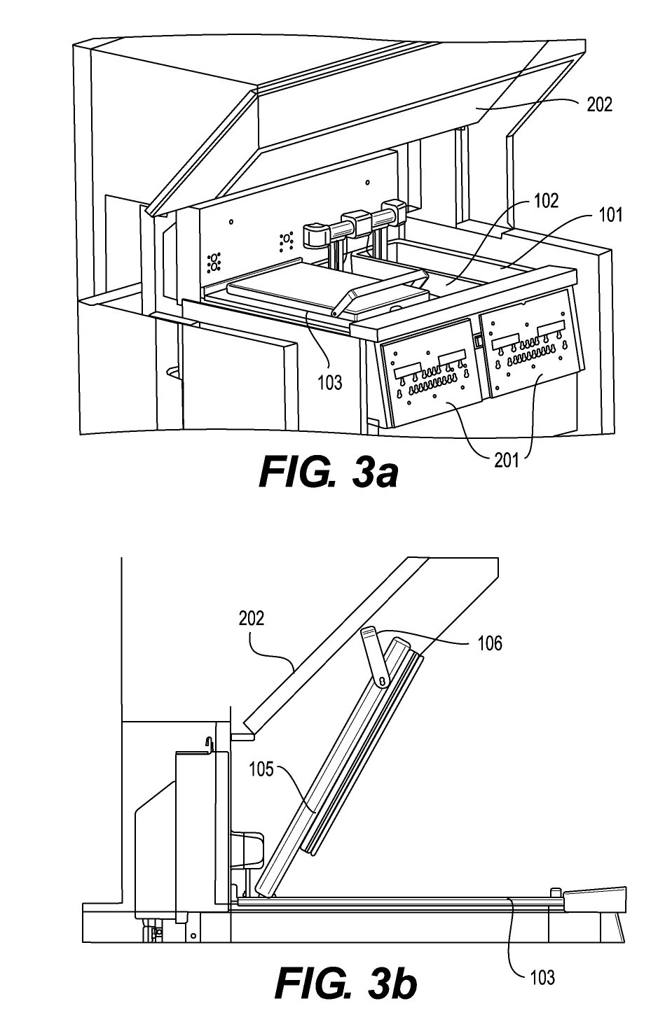

FIG. 3a illustrates fryer apparatus 100 as deployed within the back house of a typical quick service restaurant. Fryer apparatus 100 may include control panel 201 to provide for user operation. Control panel 201 may be implemented in any suitable manner such as with switches, buttons, a touch screen, or the like, and may be coupled to an electrical control mechanism, such as a printed circuit board or other circuit assembly that may include a control program in storage. As shown in FIG. 3a, fryer apparatus may provide an additional capability of pressure frying for improved menu offerings without taking up additional space. Closeable frypot 103 offers additional flexibility to be operated as an open fryer, as well. Looking at FIG. 3b, cover 105 may be open to access the opening of frypot 103 to be operated as an open fryer. In one exemplary embodiment, cover may be opened 50° or more to facilitate access to closeable frypot 103 and an angle of 58° is shown in FIG. 3b. Handle 106 may engage ventilation hood 202 to secure cover 105 when closeable frypot 103 is operated as an open fryer or when food is loaded into or unloaded from frypot 103 in relation to a pressure frying operation.

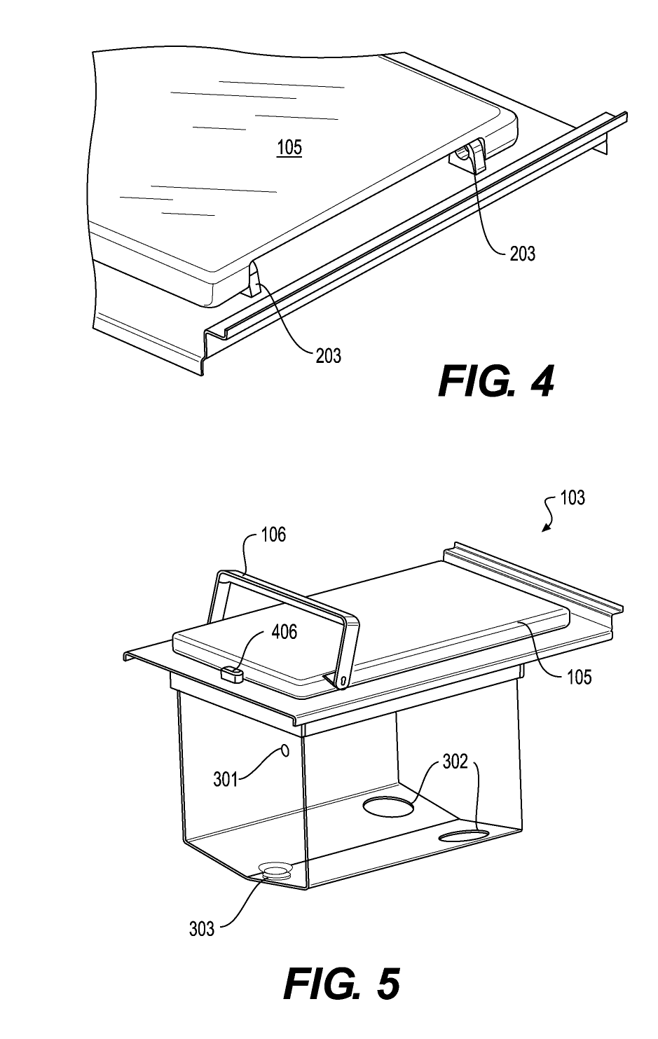

FIG. 4 illustrates a rear hinge configuration for cover 105 of an embodiment on the invention. Hinge 203 at a rear of cover 105 is offset from a rear edge of fryer apparatus to provide a space for cover 105 rotate into an open position. Hinge 203 of cover 105 may include a hold open mechanism or otherwise be biased, by a spring for example, to keep cover 105 in an open position, such as shown in FIG. 3b.

FIG. 5 shows a selectively closeable frypot according to an embodiment of the invention. Closeable frypot 103 includes apertures 301 for a pressure assist feature to more precisely control the pressure within closeable frypot 103. Such a pressure assist feature is critical with the smaller batches that would typically be used with a combination fryer so that the pressure fryer achieves a desired pressure in a more efficient manner. The pressure assist feature can be provided by a filter motor or a dedicated motor. Examples of such a pressure assist feature are described in U.S. patent application Ser. No. 14/077,930 (filter motor) and U.S. Provisional Patent Application No. 62/281,503 (dedicated motor), the disclosures of which are incorporated herein by reference in their entirety.

Closeable frypot 103 includes inlet 302 and outlets 303 coupled to a filter unit. Filtering of cooking medium improves cooked food quality and extends the operational life of cooking medium. Fryer apparatus may have one filter unit for all frypots, one filter unit per frypot, or any number of filter units in between. Thus, the fryer apparatus may be designed based upon the desire to segregate cooking medium, filter multiple frypots at once, or any other unanticipated circumstance. Moreover, in more compact applications, fryer apparatus may comprise a single selectively closeable frypot that can be used for both open and pressure frying operations. Elements of a filtering system such as motor, filtering media, and fluid communication pathway are shown in U.S. Pat. No. 8,689,679 and U.S. Pat. No. 9,228,965, the disclosures of which are incorporated herein by reference in their entirety. Filtration may be fully automated and the frequency of filtration occurs based upon user preferences up to and including after each cook load.

The size of closeable frypot 103 may be flexible based upon application but may be narrow enough to fit a single boneless chicken filet's width ranging up to three industry standard half baskets. Exemplary capacity of closeable frypot 103, in view of space constraints where fryer apparatus 100 may be deployed, may be 0.5-6 lbs. of breaded chicken or similar food product. Moreover, the size of closeable frypot 103 may be optimized to ensure proper balance of cooking efficiency and oil savings, and may have an oil capacity range of 12-48 lbs. of oil.

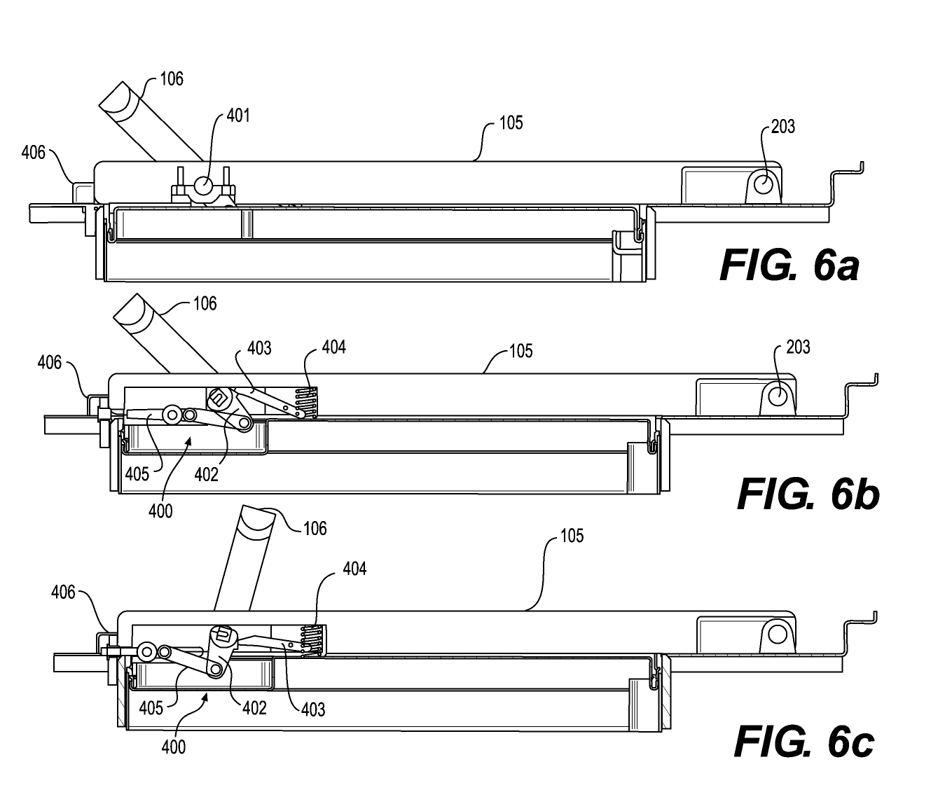

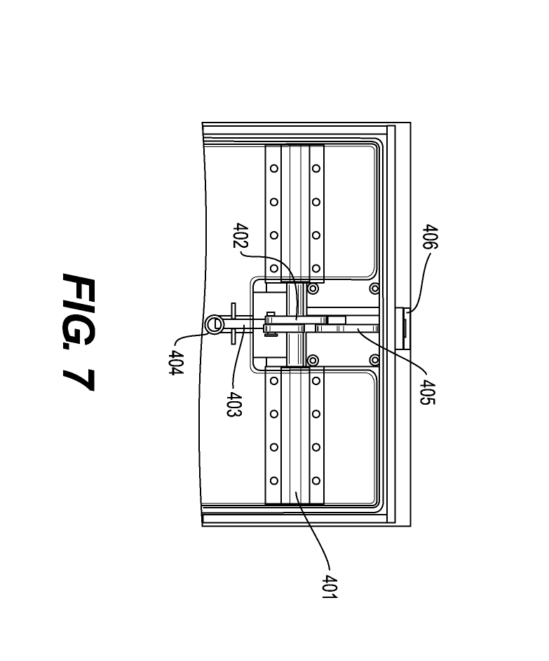

FIGS. 6a-6c illustrate an exemplary embodiment of a locking mechanism 400 for cover 105 of selectively closeable frypot 103. FIG. 6a shows handle 106 coupled to a rotatable pin 401 extending along a width of cover 105. Rotatable pin 401 is configured to rotate in response to actuation of handle 106 from the locked and unlocked positions. FIG. 6b is a cross-sectional view of cover 105 showing locking mechanism 400 in an unlocked position. Handle 106 may be offset from a front of cover 105 to accommodate locking mechanism 400 within cover 105. Locking mechanism 400 may include an eccentric cam 402 configured to rotate with pin 401 and engage a lever 403 against a biasing force which may be provided by spring 404. The biasing force prevents accidental locking of closeable frypot 103 and gives an operator tactile feedback that cover 105 is locked. Rotation of pin 401 may also effect movement of a hinged latch 405 from locked and unlocked positions. Hinged latch 405 may be configured to extend through a front face of cover 105 selectively engage a strike 406 in response to the rotation of handle 106 and pin 401. Strike 406 may include an aperture or other mechanism for engaging a distal end of hinged latch 405 to securely lock cover 105 to adequately seal closeable frypot 103 for pressure frying operation.

FIG. 6c illustrates locking mechanism 400 in a locked position. Handle 106 may be rotated towards a rear of cover 105 causing pin 401 to rotate cam 402. The rotation of handle 106 causes lever 403 overcomes the force of spring 404. Concurrently, hinged latch 405 extend through cover 105 to engage strike 406. Lever 403, biased by spring 404, engages a surface of cam 402 to secure hinged latch 405 in a locked position engaged with strike 406.

FIG. 7 is a plan view of locking mechanism 400 according to an embodiment of the invention. Pin 401 may extend substantially along the width of lid 105. Cam 402 may be configured to translate the rotation of pin 401 to the lateral movement of hinged latch 405 towards a front of cover 105 such that hinged latch 405 is in locking engagement with strike 406. The compact arrangement of locking mechanism 400 within cover 105 is ideal for providing a pressure frying capability within the spatial space constraints of many limited service restaurants.

While the invention has been described in connection with preferred embodiments, it will be understood by those of ordinary skill in the art that other variations and modifications of the preferred embodiments described above may be made without departing from the scope of the invention. For example, fryer apparatus 100 may be a gas or an electric powered fryer. Other embodiments will be apparent to those of ordinary skill in the art from a consideration of the specification or practice of the invention disclosed herein. The specification and described examples are considered exemplary only, with the true scope and spirit of the invention indicated by the following claims.

1. A combination pressure and open frying apparatus, comprising:
at least one selectively closeable frypot configured to cook food product, the selectively closeable frypot including an access opening for food product;
a cover configured to selectively close the access opening and seal the selectively closeable frypot, the cover being movable from a closed position to an open position;
a locking mechanism disposed within the cover, the locking mechanism configured to lock the cover in the closed position; and
a handle offset from a front of the cover and configured to actuate the locking mechanism, the handle configured to move from a locked position that locks the cover and an unlocked position that unlocks the cover,
wherein the locking mechanism comprises a pin extending in a width direction operatively coupled to a latch, the pin being coupled to the handle and configured to move the latch in a direction generally perpendicular to the width direction to selectively lock the cover;
wherein the latch is configured to extend through an opening in the front of the cover to engage a strike to lock the cover, and
wherein the selectively closeable frypot is configured to operate as a pressure frying platform when the cover is locked in the closed position and the selectively closeable frypot is configured to operate as an open pressure frying platform when the cover is in the open position.

2. The frying apparatus of claim 1, further comprising an air pump operatively connected to the at least one selectively closeable frypot,
wherein the air pump is configured to pressurize the at least one selectively closable frypot to a predetermined air pressure.

3. The frying apparatus of claim 1, further comprising at least one open frypot configured to cook food product, the open frypot configured to operate as another open pressure frying platform.

4. The frying apparatus of claim 3, further comprising a common filtering unit that is operatively connected to the at least one open frypot and the at least one selectively closeable frypot,
wherein the common filtering unit is configured to filter cooking medium from each of the at least one open frypot and the at least one selectively closeable frypot.

5. The frying apparatus of claim 3, further comprising:
a first filtering unit that is operatively connected to the at least one open frypot; and
a second filtering unit that is operatively connected to the at least one open frypot,
wherein each of the first and second filtering units are configured to separately filter cooking medium from each of the at least one open frypot and the at least one selectively closeable frypot, respectively.

6. The frying apparatus of claim 1, wherein the cover is coupled to the frying apparatus by a hold open hinge configured to hold the cover in the open position when the selectively closeable frypot is configured to operate as the open frying platform.

7. The frying apparatus of claim 1, wherein the handle of the cover is configured to engage a portion of a ventilation hood to hold the cover in the open position.

8. The frying apparatus of claim 1, wherein the locking mechanism further comprises:
an eccentric cam coupled to the pin, the cam configured to rotate with the pin;
a lever engaging an engagement portion of the cam to move from a lever open position to a lever locked position; and
a biasing member configured to bias the lever in the lever locked position to securely engage the latch with the strike to lock the cover.

9. The frying apparatus of claim 1, wherein the cover in the open position is opened at least 50° relative to the access opening of the selectively closeable frypot.

10. The frying apparatus of claim 1, wherein the latch is a hinged latch comprising:
a first hinge portion operatively connected to the pin; and
a second hinge portion pivotally connected to the first hinge portion, the second hinge portion including a distal end configured to engage the strike to lock the cover.

11. The frying apparatus of claim 3, wherein the apparatus includes at least two open frypots or at least two selectively closable frypots, to provide a varied configuration of open and closable frypots.

12. The frying apparatus of claim 8, wherein at least a portion of elements defining the locking mechanism are enclosed within the cover, to provide a compact arrangement for the at least one selectively closable frypot.

13. A cover configured to selectively close an access opening into a selectively closable frypot in a combination pressure and open frying apparatus, the cover comprising:
a locking mechanism including a pin extending in a width direction and operatively coupled to a latch, wherein the latch is configured to extend through an opening in the cover to lock the cover in a closed position; and
a handle configured to actuate the locking mechanism, the handle coupled to the pin and configured to move from a locked position that locks the cover and an unlocked position that unlocks the cover, the handle also configured to move the cover between the closed position and an open position,
wherein at least a portion of elements defining the locking mechanism are enclosed within the cover, to provide a compact arrangement for the selectively closable frypot, and
wherein the selectively closeable frypot is configured to operate as a pressure frying platform when the cover is locked in the closed position and the selectively closeable frypot is configured to operate as an open pressure frying platform when the cover is in the open position.

14. A combination pressure and open frying apparatus, comprising:
at least one selectively closeable frypot configured to cook food product, the selectively closeable frypot including an access opening for food product;
at least one open frypot configured to cook food product, the open frypot configured to operate an open pressure frying platform;
a cover configured to selectively close the access opening and seal the selectively closeable frypot, the cover being movable from a closed position to an open position;
a locking mechanism disposed within the cover, the locking mechanism configured to lock the cover in the closed position; and
a handle offset from a front of the cover and configured to actuate the locking mechanism, the handle configured to move from a locked position that locks the cover and an unlocked position that unlocks the cover,
wherein the locking mechanism comprises a pin extending in a width direction operatively coupled to a latch, the pin being coupled to the handle and configured to move the latch to selectively lock the cover,
wherein the selectively closeable frypot is configured to operate as a pressure frying platform when the cover is locked in the closed position and the selectively closeable frypot is configured to operate as an open pressure frying platform when the cover is in the open position, and
wherein the apparatus includes at least two open frypots or at least two selectively closable frypots, to provide a varied configuration of open and closable frypots.
